(19) United States
(12) Patent Application Publication
(10) Pub. No.: US 2006/0068145 A1
(43) Pub. Date: Mar. 30, 2006

(54) Adhesive pad having sheets with removable non-adhesive section

(76) Inventor: Ashok V. Chandaria, Nairobi (KE)

Correspondence Address: SAND & SEBOLT, AEGIS TOWER, SUITE 1100, 4940 MUNSON STREET, NW, CANTON, OH, 44718-3615, US

(21) Appl. No.: 10/955,022

(22) Filed: Sep. 30, 2004

(51) Int. Cl. B32B 33/00

(52) U.S. Cl. 428/40.1

(57) ABSTRACT

An adhesive notepad comprising a plurality of sheets of notepaper, each of which include a front surface and a rear surface having an adhesive strip applied thereto. Each sheet further includes a line of perforations which allow the sheet to be separated into two smaller sections. The perforations are positioned in such a manner that one of the smaller sections will include the adhesive strip and the other smaller section will be adhesive free. This allows the sheet of notepaper to be used both as a sticky note and as a small piece of adhesive free paper.

### BACKGROUND OF THE INVENTION

1. Technical Field

This invention generally relates to adhesive pads made up from a plurality of sheets having an adhesive thereon. More particularly, the invention relates to an adhesive pad in which the sheets include perforations along which the sheet may be divided into at least two sections. Specifically, the invention relates to an adhesive notepad where the sheets include perforations that enable the sheets to be divided into an adhesive containing portion and a non-adhesive containing portion.

2. Background Information

Notepad sheets, having an adhesive strip on their rear surface, are frequently used in business settings for many purposes, including writing brief notes relating to files or documents. These notepad sheets, or sticky notes as they are frequently referred to, are individually removed from the pad and are then stuck via the adhesive strip to another surface such as that of files, books or other documents. Sometimes, however, it is undesirable to have the adhesive strip on the sheet once the sheet has been removed from the notepad. For example, the user may have written a phone number down and does not wish to stick the sheet to a surface, but instead wishes to put the sheet into a pocket or purse to serve as a reminder at a later time. In these instances, an adhesive sheet has a tendency to stick to objects within the pocket or purse and may thereby become crumpled, dirty and difficult to extract in one piece.

There is therefore a need in the art for an adhesive notepad in which the notepad sheets may be used either with or without the adhesive portion thereon.

### SUMMARY OF THE INVENTION

The adhesive notepad comprises a plurality of sheets of notepaper, each of which include a front surface and a rear surface having an adhesive strip applied thereto. Each sheet further includes a line of perforations which allow the sheet to be separated into two smaller sections. The perforations are positioned in such a manner that one of the smaller sections will include the adhesive strip and the other smaller section will be adhesive free. This allows the sheet of notepaper to be used both as a sticky note and as a small piece of adhesive free paper.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of an adhesive notepad comprising a plurality of sheets of adhesive notepaper in accordance with the present invention;

FIG. 2 is a rear elevational view of a sheet of adhesive notepaper as shown in FIG. 1;

FIG. 3 is a front elevational view of the sheet of FIG. 1; showing the sheet being separated into two components parts along the line of perforations;

FIG. 4 is a rear elevational view of the sheet of FIG. 3, showing the sheet separated into two smaller parts, the first having the adhesive strip thereon and the second portion being substantially devoid of adhesive.

### DETAILED DESCRIPTION OF THE INVENTION

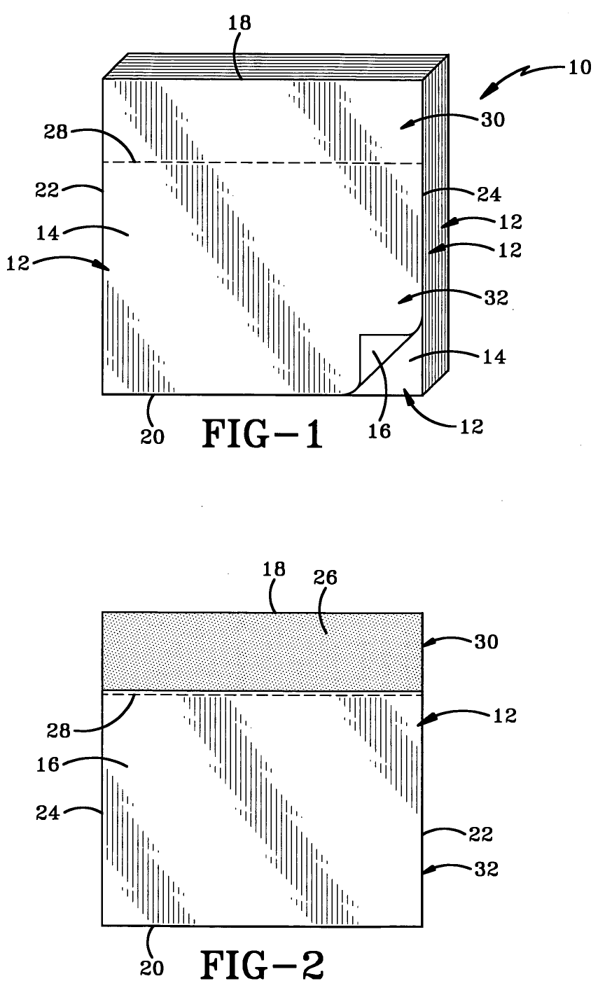

Referring to FIGS. 1 & 2, there is shown an adhesive notepad 10, comprising a plurality of sheets 12 of notepaper. Sheets 12 each have a front surface 14, a rear surface 16, a top edge 18, bottom edge 20 and side edges 22, 24. An adhesive strip 26 is applied to rear surface 16 of sheet 12.

In accordance with the present invention, sheet 12 is also provided with a line of perforations 28 which extend from side edge 22 to side edge 24. Perforations 28 divide sheet 12 into a first portion 30 and a second portion 32. Perforations are positioned so that adhesive strip 26 lies entirely on first portion 30. First portion 30 therefore contains an adhesive strip 26, while second portion 32 contains no adhesive.

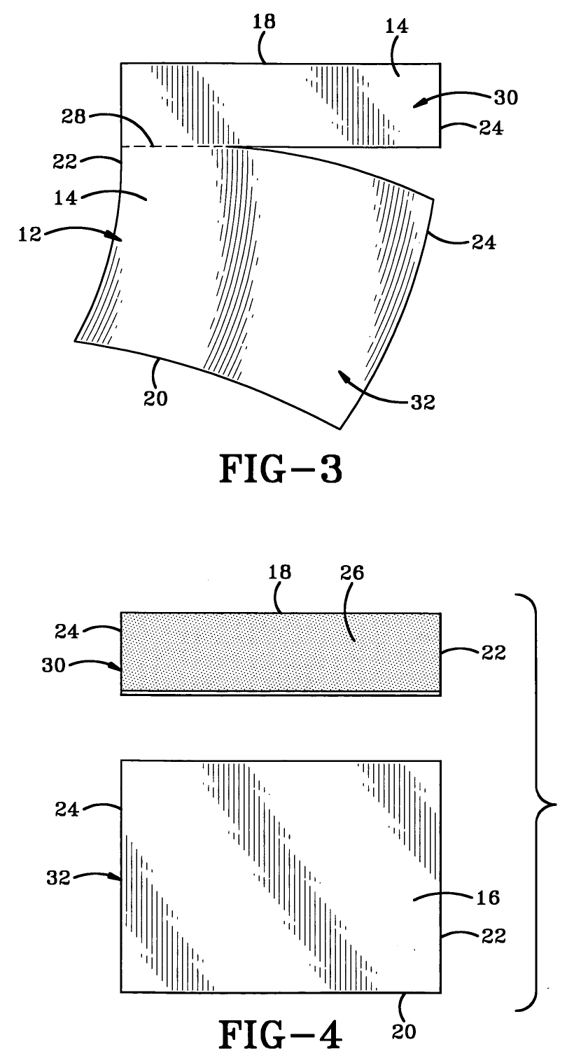

Referring to FIGS. 3 & 4, notepad 10 is used as follows. Sheet 12 is removed from notepad 10 and may be used as a whole sheet and stuck to any suitable surface desired by the user in the manner known in the prior art. In this instance the adhesive strip 26 on sheet 12 is used to attach sheet 12 to the surface (not shown). However, if it is desirable to have a piece of notepaper without any adhesive thereon, the user grasps sheet 12 and separates first portion 30 of sheet 12 from second portion 32 along perforations 28. First portion 30 includes adhesive strip 26 while second portion 32 has substantially no adhesive thereon. Sheet 12 may be separated into first and second portions 30, 32 while on pad 10, or may be separated as soon as sheet 12 is removed from pad 10, or after sheet 12 has been attached to another surface such as a file or book (not shown). The front surface 14 of either or both of first and second portions 30, 32 may be written on by the user.

It will be understood that while an adhesive strip 26 is shown as applied to rear surface 16 of sheet 12, discrete beads of adhesive or an adhesive tape may alternatively be applied across rear surface 16 of first portion 30.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An adhesive notepad comprising:
a plurality of sheets of notepaper stacked one on top of the other; each sheet having:
a front surface, a rear surface and side edges;
a plurality of perforations extending between said side edges; wherein said perforations allow the sheet to be divided therealong into a first portion and a second portion; and
an adhesive region applied only to the rear surface of the first portion of the sheet.

2. The adhesive notepad as defined in claim 1; wherein the first portion of the sheet is substantially smaller than the second portion of the sheet.

3. The adhesive notepad as defined in claim 2, wherein the adhesive region comprises a band of adhesive extending from an upper edge of the sheet to a position immediately adjacent said perforations.

4. An adhesive notepad comprising a plurality of individual sheets of notepaper each separable along a line of perforations into a first portion and a second portion; wherein the first portion includes an adhesive for adhering the first portion to a remote surface and wherein the second portion is adhesive free.

5. The adhesive notepad as defined in claim 4, wherein the first portion is substantially smaller than the second portion.

6. The adhesive notepad as defined in claim 5, wherein the perforations lie substantially parallel to an upper edge of the sheet of notepaper.

7. The adhesive notepad as defined in claim 6, wherein the perforations extend from a first side edge of the sheet to a second side edge thereof.
